(19) United States
(12) Patent Application Publication
(10) Pub. No.: US 2021/0054189 A1
(43) Pub. Date: Feb. 25, 2021

(54) PEARLESCENT POLYESTER ARTICLES

(71) Applicant: Penn Color, Inc., Doylestown, PA (US)

(72) Inventors: Kelan Wieloch, Lansdale, PA (US); James C. Walsh, Doylestown, PA (US); Julie Cuddigan, Allentown, PA (US)

(21) Appl. No.: 16/999,500

(22) Filed: Aug. 21, 2020

Related U.S. Application Data
(60) Provisional application No. 62/890,257, filed on Aug. 22, 2019.

(51) Int. Cl. C08L 67/02

(52) U.S. Cl. CPC C08L 67/02; C08L 2203/10; C08L 2310/00

(57) ABSTRACT

The present disclosure relates to a glossy, uniform pearlescent appearance in an oriented polyester article without the use of pearlescent or metallic pigments.

This application claims the benefit of priority to U.S. Patent Application No. 62/890,257 filed Aug. 22, 2019, the disclosure of which is hereby incorporated by reference in its entirety.

### FIELD

The present disclosure relates to a glossy, uniform pearlescent appearance in an oriented polyester article having little to no pearlescent or metallic pigments.

### BACKGROUND

Pearlescence is generally imparted in two ways: (i) with pearlescent, interference, or metallic effect pigments, or (ii) with an incompatible polymer.

Pearlescent, interference or metallic effect pigments are high aspect ratio inorganic particles. When they are added to a polyester, they reflect light back toward the light source to create a lustrous appearance. In some cases, the composition of the pigment is such that constructive or destructive light interference occurs, giving the appearance of certain colors at certain angles. Some metallic effects are highly reflective, while pearlescent and interference effects may range from semi-transparent to semi-opaque.

Incompatible polymers can be incorporated into a polyester through melt mixing under high shear. The incompatible polymer forms into droplets as the polyester is formed into a preformed (unoriented) article. When the article is oriented, internal voids may form within the polyester and stretch during orientation. The stretched voids behave in a similar manner to pearlescent particles with a high aspect ratio. Areas of light reflection, and not light scattering, create a lustrous or pearlescent effect due to the difference in refractive index between the polyester matrix (RI=1.57) and air (RI=1.00). Examples of this include polypropylene and polymethylpentene. Some incompatible polymers may not create voids and instead will elongate along with the polyester. This will create a similar effect as voids, however the difference in refractive index between the polyester and the incompatible polymer is much smaller than the difference in refractive index between the polyester and air. This creates a more translucent but also lustrous appearance. Examples of this behavior are seen with linear low-density polyethylene or high molecular weight silicone.

These two main alternative technologies—pure mineral fillers and incompatible polymers—have distinct disadvantages.

With respect to pearlescent or metallic effect pigments are high aspect ratio inorganic particles, under orientation, rigid particles create disruptions at the surface that cause the article to lose gloss. Although pearlescence is maintained, the surface appearance is more matted.

Pearlescent particles are generally coated with titanium dioxide (TiO₂), and can lead to polymer degradation in processing, reducing the physical properties of the article. Particles can agglomerate and cause stress concentration points, leading to loss in physical properties, and causing filtration problems, especially in recycling. Due to the higher density, the final weight of the article increases, raising cost. There is a need to reduce the amount of particles in plastics throughout parts of Europe (in particular, France) to minimize the problems associated with recycling. Pearlescent particles can cause abrasion and plate out issues in extruders, pull rollers, spinnerets, and internal processing parts such as gates, pins, and molds. Mineral fillers also require a pre-made concentrate or master batch to disperse and meter the mineral filler. Other polyesters are traditionally used as a binder for the mineral filled master batch. That polyester binder can also accelerate degradation of the polyester, reduce viscosity, and add extra cost. Finally, pearlescent particles are not recyclable into fiber due to the large particle size and aspect ratio.

With respect to incompatible polymers, pearlescence is created after orientation in one of two ways—internal voids or stretching of the incompatible polymer. For voiding, pearlescence is generated due to reflection from the difference in refractive index between the polyester and air. Since the refractive index difference is high, >0.3 units, more light is reflected than transmitted, creating high opacity. When this happens, the resulting article, especially with colorant, lacks visual appeal and depth of color. It will still be pearlescent and opaque, but the appearance will suffer. The appearance will also vary across an article that has uneven stretching. For example, a PET bottle that has a narrow neck (like a trigger spray bottle) can have low orientation at the neck, and much higher orientation at the side wall. This difference changes the appearance in those areas, leaving the article non-uniform.

For polymers that do not void, such as polyethylene or high molecular weight silicone, the polymer may elongate as the PET orients, creating a long plate-like structure that also behaves like a pearlescent particle. Since the difference in refractive index between the polyester (RI=1.57) and incompatible polymer (e.g., RI=1.45) is relatively small, <0.2 units, the amount of light reflected is not enough to generate high opacity. Instead, the light interacts with several interfaces throughout the article, including any dyes or pigments present. The effect of this is a high color depth that cannot be easily measured but is obvious to see. Since this appearance also varies with orientation, the appearance will change if there are any differences in orientation across the article. Also, the high transparency requires a high loading level of the incompatible polymer to create a lustrous effect.

Given the foregoing, there is a need for improved pearlescent polyester articles.

### SUMMARY

In one aspect, the disclosed technology relates to an oriented, pearlescent article including one or more layers, wherein at least one layer is a composition including: polyester; and incompatible polymer selected from COC, partially hydrogenated styrenic polymers and copolymers, and combinations thereof; wherein the article is oriented and has a pearlescent gonioappearance of more than 15 units DE_{CMC} when measured between a 15° viewing angle and a 110° viewing angle from a 45° illuminant. In some embodiments, the layer has a pearlescent gonioappearance of more than 10 units DE_{CMC} when measured between a 15° viewing angle and a 110° viewing angle from a 45° illuminant. In some embodiments, the incompatible polymer has a glass transition temperature that is lower than the orientation temperature of the article. In some embodiments, the polyester is polyethylene terephthalate (PET). In some embodiments, the composition includes at least 85 wt % polyester, based on the total weight of the composition. In some embodiments, the incompatible polymer includes a hydrogenated styrenic polymer. In some embodiments, the incompatible polymer includes COC. In some embodiments, the composition includes about 15 wt % or less incompatible polymer, based on the total weight of the composition.

In some embodiments, the composition further includes an additive or colorant. In some embodiments, the composition includes an additive selected from anti-block agents, anti-oxidants, anti-stats, slip agents, chain extenders, cross linking agents, flame retardants, IV reducers, laser marking additives, mold release, optical brighteners, flow aids, colorants, plasticizers, pigment, dyes, nucleating agents, oxygen scavengers, anti-microbials, UV stabilizers, and combinations thereof. In some embodiments, the composition includes a colorant selected from dyes, organic pigments, inorganic pigments, and combinations thereof. In some embodiments, the colorant includes a combination of dyes. In some embodiments, the article is a container.

In another aspect, the disclosed technology relates to a method of manufacturing a pearlescent article, including the steps of: (a) melt blending polyester with incompatible polymer selected from COC, partially or fully hydrogenated styrenic polymers and copolymers, and combinations thereof to produce a composition including about 15 wt % or less of incompatible polymer, based on the total weight of the composition; (b) subjecting the composition to orientation stress at a temperature above the glass transition temperature of the incompatible polymer; and (c) producing an article that has a pearlescent gonioappearance of more than 15 units DE_{CMC} when measured between a 15° viewing angle and a 110° viewing angle from a 45° illuminant. In some embodiments, at least one additive or colorant is added to the composition during step (a).

### BRIEF DESCRIPTION OF THE DRAWINGS

FIG. 1 is a diagram of the CIELAB L*, a*, b* color space.

FIG. 2 is a diagram of an example multi-angle color measurement for determining the gonioappearance of an article using a 45° incident light source and measuring color at near-specular (15°) and far specular (110°) angles.

### DETAILED DESCRIPTION

The present disclosure relates to articles made from a polyester matrix resin and less than 10 wt % of an incompatible polymer selected from COC, partially or fully hydrogenated styrenic polymers and copolymers, and combinations thereof, wherein the article is oriented at a temperature above the glass transition temperature (T_{g}) of the incompatible polymer, resulting in a uniform pearlescent article. Non-limiting examples of suitable articles include bottles and other containers, sheets, films, thermoformed parts, fibers, and packages for containing various consumer products.

### Polyester

The disclosed compositions include a major polymeric component that is a polyester matrix resin (also interchangeably referred to herein as the polyester polymer or matrix polymer), which can be any polyester suitable for manufacturing bottles or other containers, sheets, films, thermoformed parts, fibers, or other types of articles. Non-limiting examples of suitable polyester polymers for use in compositions for making the disclosed articles include polyester terephthalate (PET), PET homopolymers, PET copolymers with glycol, PET copolymers with cyclohexanedimethanol (CHDM), PET copolymers with isophthalic acid (IPA), polylactic acid (PLA), polybutylene terephthalate (PBT), polytrimethylene terephthalate (PTT), polycyclohexylenedimethylene terephthalate (PCT), polyethylene naphthalate (PEN), polyethylene furanoate (PEF), and combinations thereof

The polyester polymer comprises the majority of the composition. In some embodiments, the composition includes polyester polymer (e.g., PET) in an amount of at least 90 wt %, at least 92 wt %, at least 94 wt %, at least 95 wt %, at least 96 wt %, at least 97 wt %, or at least 98 wt %, based on the total weight of the composition (e.g., a layer of a finished article, as further described below).

### Incompatible Polymer

The disclosed compositions include “incompatible polymer,” which refers to a minor polymeric component that forms phase-segregated domains in the matrix polymer under heat and shear conditions of an extruder. The incompatibility and size of the phase-segregated domains can be driven by differences in molecular weight, rheology, chemical composition, surface energy and processing conditions such as shear, temperature, humidity, among others. Non-limiting examples of suitable incompatible polymers for use in compositions for making the disclosed articles include cyclic olefin copolymers, cyclic olefin polymers, partially or fully hydrogenated styrenic polymers, and combinations thereof. As used herein, the term “COC” refers to both cyclic olefin copolymers and cyclic olefin polymers.

Cyclic olefin copolymers include copolymers of ethylene and norbornene or ethylene and tetracyclodecene. For example, some such polymers are commercially available from Polyplastics as TOPAS® (COC), Zeonex as ZEONOR® (COC), and Mitsui as APEL™ (COC). The grades available from Zeonex are referred to as cyclic olefin polymers due to the difference in polymerization and a subsequent hydrogenation process. Other examples of COC include grade TOPAS® 8007F-04 available from Polyplastics, which may be used in some embodiments within a polyester terephthalate (PET) matrix for injection stretch blow molding (ISBM) because TOPAS® 8007F-04 has a T_{g} of 78° C., which is below the approximate 95° C. to 120° C. orientation temperature of PET in an ISBM process. Conversely, TOPAS® 5013F-04, another COC available from Polyplastics, has a relatively high T_{g} of 133° C., and does not produce a pearlescent appearance under the same orientation conditions.

Hydrogenated styrenics include, for example, fully hydrogenated styrene butadiene copolymers commercially available from Mitsui under the trade name VIVION™. Other non-limiting examples of suitable hydrogenated styrenics include fully hydrogenated polystyrene (also known as polycyclohexylethylene or polyvinylcyclohexane), fully or partially hydrogenated styrene-isoprene copolymers, other partially or fully hydrogenated styrenic copolymers, and combinations thereof. VIVION™ 8210 is a fully hydrogenated styrenic cyclic block copolymer with a relatively low Vicat Softening Point of 105° C., which falls within the range of the PET orientation temperature during ISBM and thus may result in a gonioapparent (pearlescent) article having higher light transmission.

Suitable incompatible polymers have a glass transition (T_{g}) lower than the orientation temperature of the article. If the glass transition (T_{g}) temperature is higher, then the article will have internal voids and high opacity, losing color depth, pearlescence, and uniformity. Barrier to gases like oxygen and carbon dioxide is also important for content protection.

With an insufficient gas barrier, carbonated beverages can lose carbon dioxide and become flat. Oxygen can degrade food products and cause rancidity. Methods to improve oxygen barrier for polyester, such as PET, may include the use of a cobalt catalyst in the presence of a degradable polymer as an active barrier. Active barriers, such as oxygen scavengers, are consumed and eventually stop being effective. Passive barriers can be more beneficial because they are generally not consumed and can be used in combination with active barriers. Mixtures of polyesters and incompatible polymers as disclosed herein may improve the passive barrier to oxygen, carbon dioxide, or other gases.

Thus, the present disclosure provides a uniform pearlescent appearance without any particulate. Using just a polymer avoids the use of particles, which can cause degradation of PET and processing problems such as abrasion and die buildup, so recyclability into bottles, fiber or thermoformed parts is improved. The disclosed technology also uses a COC, which has advantages over other polymers: it does not degrade at PET processing temperatures; it can be used as a carrier for dyes; it may provide water vapor barrier; and it can be used for oxygen barrier.

In the disclosed articles, pearlescence can be achieved with relatively small loadings of the incompatible polymer in the composition—e.g., about 4 wt % or less, about 3 wt % or less, about 2 wt % or less, about 1 wt % or less, based on the total weight of the composition (e.g., the total weight of a layer comprising the disclosed composition as provided in a bottle or other article).

The articles disclosed herein may comprise one or more layers, wherein at least one layer comprises a disclosed composition. After orientation of the composition, the resulting article (or a layer thereof) has a pearlescent appearance. As used herein, a “layer” refers to a macro-scale layer of the material forming an article. In some embodiments, a layer has a thickness of about 0.05 mm to about 5 mm, about 0.1 mm to about 3 mm, or about 0.2 mm to about 2 mm. In some embodiments, the layer comprises a side wall of an article. Weight percentages of components included in the disclosed compositions are described as being based on the total weight of the composition, which is the same as being based on the total weight of the layer in which the composition is present, rather than being based on the total weight of the whole article (unless, of course, the whole article is formed of a single layer).

Non-limiting examples of suitable articles include bottles and other containers, sheets, films, thermoformed parts, fibers, and packages for containing various consumer products.

The disclosed technology also includes a method of manufacturing an article by melt blending polyester and incompatible polymer through an extruder and forming a part, orienting the part at a temperature above the glass transition (Tg) of the incompatible polymer so that the resulting article is uniformly pearlescent.

Without being limited by the mechanism, it is believed that the cyclic olefin copolymers or partially or fully hydrogenated styrenic polymers and copolymers are incompatible with the polyester and forms distinct polymeric phases within the polyester matrix. When the polyester is oriented above the Tg of the incompatible polymer, the dispersed phase stretches along with the polyester and creates elongated platelets. These platelets, due to the difference in refractive index, reflect light in a similar manner to pearlescent particles to provide a lustrous or pearlescent appearance. However, unlike pearlescent particles, the polymer does not disrupt the surface, leaving a glossy, lustrous appearance. In some embodiments, adding a pigment or dye creates a metallic, glossy appearance that is not achievable with other methods.

The appearance achieved with the disclosed incompatible polymers has a depth of color that is different from a lustrous appearance produced from voiding and is more uniform than that achieved with other polymers. Compared to polypropylene and polymethylpentene, which void and create opacity, cyclic olefin copolymers provide a much more uniform result.

In some embodiments, a master batch containing about 90 wt % incompatible polymer and about 10 wt % of a combination of dyes or transparent pigments is prepared by running these ingredients through a single or twin screw extruder at a temperature suitable for melt processing the cyclic olefin copolymer, and then cutting into pellets. About 3 wt % of the master batch (more for thin gauge articles and less for heavy gauge articles) is added to about 97 wt % of a polyester polymer, melt processed into a preformed article and then stretched to a total area draw of at least 5×². In some embodiments, is about 1 wt % to about 5 wt % of master batch is combined with about 95 wt % to about 99 wt % of the polyester.

Using a incompatible polymer with a glass transition (Tg) below the orientation temperature of the article creates a lustrous, uniform, semi-transparent appearance. Additionally, it is believed that the Tg of an incompatible polymer having a relatively low Tg can be increased by blending with a miscible incompatible polymer having a higher Tg, which raises the overall Tg of the blend of incompatible polymers. Raising the Tg to a temperature above the orientation temperature of the composition containing polyester and incompatible polymer can result in an article that is pearlescent.

Cyclic olefin copolymers and partially hydrogenated styrenic polymers and copolymers do not degrade under polyester terephthalate (PET) processing conditions, so there is no generation of not intentionally added substances (NIAS). Some polymers, such as polystyrene, polymethylmethacrylate, polyvinylchloride, or polymethylpentene (PMP) degrade at some polyester processing temperatures to generate unintended substances such as styrene monomer or valeric acid. These NIAS can be toxic or alter the taste and odor in the case of food packaging. In some embodiments, the composition contains 0 wt %, less than 0.5 wt %, or less than 1 wt % of one or more of polystyrene, polymethylmethacrylate, polyvinylchloride, and polymethylpentene.

The disclosed technology creates a lustrous appearance without any non-melting inclusions (e.g. mineral fillers, organic pigments, or special effect pigments such as pearlescent colorants). Eliminating non-melting inclusions leads to improved recyclability due to less degradation of the polyester and no particulate agglomeration. Eliminating non-melting inclusions lowers the density and part weight, saving cost. The cyclic olefin copolymer is unusual among polyolefins in that it can solubilize dyes and act as a master batch polymer without the dyes bleeding or migrating out of the master batch.

Only a small fraction of incompatible polymer is needed to create the deep, lustrous, uniform appearance. For example, the incompatible polymer content may be less than or equal to 10 wt %, less than or equal to 5 wt %, or less than or equal to 3 wt %, based on the total weight of the composition of the preform composition. Other polyolefins such as low density polyethylene require up to three times the loading level to achieve the same appearance. Compared to linear low density polyethylene (LLDPE), for example, the disclosed incompatible polymers or blends of those polymers require about three times less to create the same appearance. The higher loading of LLDPE reduces physical properties and leads to higher cost. The polyester may be present in the composition of the preform in an amount of at least 90 wt %, at least 95 wt %, or at least 97 wt %, based on the total weight of the preform composition.

The disclosed incompatible polymers and polymer blends thereof have a high barrier to water vapor and very low absorption. This may lead to enhanced barrier performance for water vapor loss.

The disclosed incompatible polymers and polymer blends thereof do not have an impact on oxygen scavenging capacity, nor do they impact some catalysts such as cobalt. The disclosed incompatible polymers and polymer blends thereof may act as a degradable polymer in an oxygen scavenging system.

For applications that require infrared (IR) reheating, such as two-stage injection stretch blow molding, a preformed structure prior to orientation (generally known as a preform) can more readily be reheated because IR light is not reflected until after orientation.

### Additional Components

One or more additional components (e.g., additives, colorants) may optionally be included in the disclosed compositions for use in making pearlescent polyester articles.

One or more additives may optionally be included in the disclosed compositions for use in making pearlescent polyester articles. Non-limiting examples of suitable additives include anti-block agents (e.g., silica), anti-oxidants (e.g., primary phenolic anti-oxidant IRGANOX® 1010), anti-stats (e.g., glycerol monostearate), slip agents (e.g., erucamide), chain extenders (e.g., carbonyl biscaprolactam), cross linking agents (e.g., pyromellitic dianhydride), flame retardants (e.g., alumina trihydrate), IV reducers (e.g., AMP-95TH), laser marking additives (e.g., IRIOTEC® 8835), mold release (e.g., calcium stearate), optical brighteners (e.g., Optical Brightener OB-1), flow aids (e.g., DAIKIN PPA DA-310ST), plasticizers (e.g., polyester copolymers), nucleating agents (e.g., talc), oxygen scavengers (e.g., OXYCLEAR®), anti-microbials (e.g., triclosan), UV stabilizers (e.g., TINUVIN 234), acetaldehyde scavengers (e.g., anthranilamide), coupling agents (e.g., OREVAC® 18507), compatibilizers (e.g., OREVAC® CA 100), non-mineral fillers such as cross linked silicone (e.g., TOSPEARL 1110A), cross linked polystyrene (TECHPOLYMER SBX-8) or cross linked PMMA (GANZPEARL GMX-0610), mineral fillers (e.g., TiO₂), and combinations thereof.

In some embodiments, the composition may contain little to no mineral filler—e.g., about 4 wt % or less, about 3 wt % or less, about 2 wt % or less, about 1 wt % or less, about 0.5 wt % or less, or 0 wt %, based on the total weight of the composition.

One or more colorants may optionally be included in the disclosed compositions for use in making pearlescent polyester articles. Non-limiting examples of suitable colorants include: dyes (e.g., solvent red 135), organic pigments (pigment blue 15:1), inorganic pigments (e.g., iron oxide pigment red 101), effect pigments (e.g., aluminum flake), and combinations thereof. Pigments, such as TiO₂ or other inorganic or organic pigments, may also be used in the compositions to color the article or a layer thereof. Colorants can enhance the opacity of an article or a layer thereof by creating additional scattering sites and/or by absorbing light at particular wavelengths, such as visible, UV, and IR.

Of particular interest are dyes since COC, unlike other olefin polymers, can solubilize dyes without significant bleed issues. This allows the COC to be used as a carrier for a master batch. Pigment, such as TiO₂ or other inorganic or organic pigments may be used to color the article. However, the amount or size of those pigments may scatter light and offset some of the lustrous appearance.

In some embodiments, the composition may contain an impurity, such as a polymer that degrades under the processing conditions of the polyester in a low amount of 0 wt % to 1.0 wt %, such as 0 wt % to 0.5 wt %, based on the total weight of the composition. For example, contemplated impurities include polystyrene (PS), styrene acrylonitrile (SAN), acrylonitrile butadiene styrene (ABS), polyvinylchloride (PVC), thermoplastic polyurethane (TPU), inert mineral fillers (e.g., calcium carbonate (CaCO₃)), catalyst residue (e.g., antimony or titanium), or a combination thereof. Impurities are not preferred but may be tolerated in low amounts. Miscible polyester blends, such as PET and PBT, PET and PETG, or PET and PTT are not considered impurities for the purposes of the present disclosure.

### Manufacturing Methods

The present disclosure also relates to methods of manufacturing articles from the compositions disclosed herein. Some such methods include “blow molding,” which refers to a manufacturing process by which hollow cavity-containing articles are formed. The blow molding process begins with melting or at least partially melting or heat-softening a thermoplastic composition (e.g., masterbatch pellets, pellets containing a disclosed composition, etc.), and forming it into a preform that can then, in turn, be formed into an article by a molding or shaping step, such as extrusion through a die head, injection molding, and the like. In general, a preform is a test tube-like piece of plastic with a hole in one end through which compressed gas can pass. The preform may be clamped into a mold while air is pumped into it, sometimes coupled with mechanical stretching of the preform (known as “stretch blow-molding”). The preform may be preheated before air is pumped into it. The air pressure pushes the thermoplastic outward to conform to the shape of a mold in which the preform is contained. Once the plastic has cooled and stiffened, the mold is opened and the expanded part (an article) is removed. In general, there are three main types of blow molding: extrusion blow molding (EBM), injection blow molding (IBM), and injection stretch blow molding (ISBM).

In some embodiments, the disclosed articles may be manufactured by a method that includes the steps of melt blending polyester polymer and incompatible polymer through an extruder to form a preformed part or preform, and then orienting the preform at a temperature above the T_{g} of the incompatible polymer to form a final article having a pearlescent appearance. Without being limited by a particular theory, it is believed that the incompatible polymer forms independent and distinct phases within the polyester matrix. When the polyester is oriented above the T_{g} of the incompatible polymer, the dispersed phase (the incompatible polymer) elongates within the polyester. This will create a similar effect as voids, however the difference in refractive index between the polyester and the incompatible polymer is much smaller than the difference in refractive index between the polyester and air. This creates a more translucent but also lustrous appearance.

As used herein, “oriented” refers to an article that has been subject to a processing method for orientation. Non-limiting examples of suitable orientation processing methods include: single state injection stretch blow molding (where preforms are injection molded, equilibrated to a target temperature, and then stretched), two-stage injection stretch blow molding (where preforms are injection molded, fully cooled and stored, then fully reheated before being blown and oriented into a bottle or other shape), extrusion blow molding (where the polymer blend composition is melted and formed into a parison or preform in the melt phase, and then oriented before being fully cooled), single direction film orientation (where a sheet is formed and the stretched either in a tenter frame using clips or by using differential speed rolls and nips), biaxial sheet orientation (where a sheet is formed and then stretched sequentially using differential roll speeds followed by tenter clips on diverging rails), biaxial tubular orientation (where an annular die forms a tube which is temperature adjusted and then supported by air pressure to expand the tube to a larger size), amorphous or crystalline thermoforming (where a sheet is produced and then formed in a mold using, e.g., pressure or vacuum assist), fiber orientation (where melt extruded polymers are formed into a yarn through a spinarette which can be partially or fully oriented).

Orientation can be performed in a single direction (uniaxial) or multiple directions (biaxial). In some embodiments involving uniaxial orientation, the orientation is about 3× or higher. In some embodiments involving biaxial orientation, the total area draw ratio (first direction times second direction), is about 7.0×² or higher, about 8.0×² or higher, about 9.0×² or higher, about 10.0×² or higher, or about 7×² to about 12×².

Gonioppearance may be influenced by reflection and refraction from internal inclusions having a high aspect ratio, similar to the effect caused by pearlescent particles (e.g., TiO₂-coated mica). The influence on gonioappearance by pearlescent particles depends on the size, shape, orientation, reflection, absorption, refraction, and/or scattering effects of those particles. Incompatible polymers may behave in a similar manner, elongating into structures that have a high aspect ratio, which can result in a pearlescent appearance. In contrast, low aspect ratio voids and small size domains of a dispersed incompatible polymer may scatter light and lead to a non-pearlescent appearance. The characteristics of both the matrix polymer and the incompatible polymer can influence the size and shape of the voids, which can thereby influence the gonioappearance of the article.

The temperature of orientation can be adjusted, but typically falls within ranges suitable for the matrix polymer. For example, typical bottle grade PET with an intrinsic viscosity (IV) of about 0.80 dl/g can undergo orientation at temperatures in the range of 90° C. to 130° C., preferably in the range of 95° C. to 120° C. Orienting at too low of a temperature can lead to stress-induced crazing, and orienting at too high of a temperature can lead to premature crystallization. For multi-layer articles, processing conditions can be isolated and customized for one or more layers to influence the gonioappearance of each layer independently.

The articles disclosed herein may comprise one or more layers, wherein at least one layer comprises a disclosed composition. As used herein, a “layer” refers to a macro-scale layer of the material forming an article. In some embodiments, a layer has a thickness of about 0.05 mm to about 5 mm, about 0.1 mm to about 3 mm, or about 0.2 mm to about 2 mm. In some embodiments, the layer comprises a side wall of an article. Weight percentages of components included in the disclosed compositions are described as being based on the total weight of the composition, which is the same as being based on the total weight of the layer in which the composition is present, rather than being based on the total weight of the whole article (unless, of course, the whole article is formed of a single layer).

Non-limiting examples of suitable articles include bottles and other containers, sheets, films, thermoformed parts, fibers, and packages for containing various consumer products. In some embodiments, the article may have an internal volume of about 10 ml to about 5000 ml, about 50 ml to about 4000 ml, about 100 ml to about 2000 ml, about 200 ml to about 1000 ml, or about 10 ml to about 250 ml.

The disclosed composition may be present in a single layer of a multi-layer structure or article. For injection stretch blow molded bottles, for example, using a clear PET skin, or another colorant of functional skin layer could enhance the aesthetics. For films or injection stretch blow molded articles, nylon can be used as an oxygen barrier layer with the pearlescent layer providing aesthetics. In some embodiments, the disclosed incompatible polymers or blends of polymers can be used in one layer with the colorant used in another. A different polymer could be used in a core layer to provide opacity, such as a high glass transition (T_{g}) COC or PMP, while the low glass transition (T_{g}) incompatible polymers of the disclosed compositions could be used in the visible skin layer.

Since the glass transition (T_{g}) of the disclosed incompatible polymers and blends of polymers impacts pearlescence and opacity, different grades of incompatible polymers having different glass transition (T_{g}) values could be combined to adjust overall glass transition (T_{g}) and thus adjust both opacity and pearlescence to the desired level.

### Gonioappearance

To measure the pearlescence, a method was developed to quantify the degree. A low degree of pearlescence (i.e., a non-pearlescent gonioappearance) has an appearance does not significantly change over a range of viewing angles. To assess whether an article (or layer thereof) is pearlescent, CIELAB DE_{CMC} values may be calculated using a multi-angle spectrophotometer.

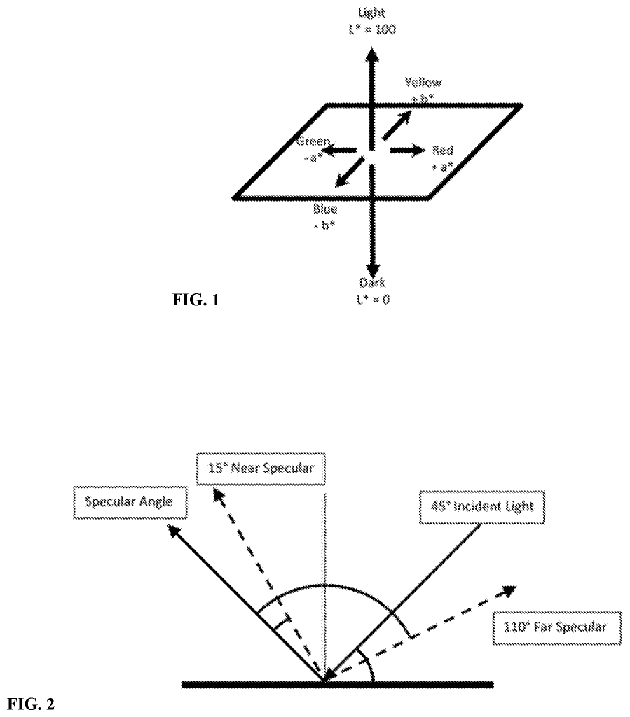

The CIELAB L*, a*, b* color space mathematically describes all perceivable colors in three dimensions: L* for lightness, a* for green-red, and b* for blue-yellow. See Hunter Lab, Applications Note, “Insight on Color,” Vol. 8, No. 7 (2008). In the CIELAB color space, the L* axis runs from top to bottom. The maximum L* value is 100, which indicates a perfect reflecting diffuser (i.e., the lightest white). The minimum L* value is 0, which indicates a perfect absorber (i.e., the darkest black). Positive a* is red. Negative a* is green. Positive b* is yellow. Negative b* is blue. See FIG. 1. CIELAB a* or b* values equal to 0 indicate no red-green or blue-yellow color appearance, in which case the article would appear pure white. In contrast, a* or b* values that deviate far from 0 indicate that light is non-uniformly absorbed or reflected. As a* or b* values deviate from 0, the color may no longer appear as bright white. One of the most important attributes of the CIELAB model is device independence, which means that the colors are defined independent of their nature of creation or the device they are displayed on.

Here, an MA-96 from X-Rite was used to measure spectral reflectance of a sample placed on top of a black Leneta card. The MA-96 uses a 45° illuminant and measures reflectance at 6 different angles −15°, 15°, 25°, 45°, 70°, and 110°, with 0° being the direct specular reflection of the 45° illuminant. Using a D65 illuminant and 10° observer, CIELAB L* a* and b* values were calculated for each measured reflectance. Since the MA-96 uses a directional illuminant, six measurements with the illuminant in the horizontal direction and six measurements with the illuminant in the vertical direction were averaged together. The difference in color (as calculated by DE) between reflectance at 15° and 110° was used as a measure of pearlescence.

Using a 45° incident light source and measuring color at near-specular (15°) and at far specular (110°) angles, the color difference indicates the change in appearance across the two viewing angles. See FIG. 2. A large difference in DE_{CMC} values indicates a pearlescent or metallic appearance. An large difference in DE_{CMC} values indicates a pearlescent appearance. For purposes of the present disclosure, a color change observed between a 15° viewing angle and a 110° viewing angle from a 45° illuminant is considered large and thus indicative of pearlescence if the color change difference is 15 units DE_{CMC} or more, 20 units or more, or 25 units or more, wherein DE_{CMC} is measured both parallel and perpendicular to the direction(s) of orientation. For a bottle, there are two directions of orientation—circumferential and axial. The highest measured DE_{CMC} value is selected as the measure of gonioappearance. The concept is that highly pearlescent and metallic materials reflect most of the light at angles close to specular and reflect very little light at angles far from specular.

### Visual Pearlescence

Visual assessments of pearlescence were conducted and recorded in most instances as No or Yes. “No” means the sample did not look visually pearlescent. “Yes” means the sample looked visually pearlescent. A visual assessment can confirm a quantified measurement of gonioappearance.

### Light Transmission

Light transmission was measured using an X-Rite Ci7800 spectrophotometer. The average light transmission from 400 nm to 700 nm was calculated as a percentage of light transmission. Each light transmission value presented in the examples below represents the average of six measurements.

### L* a* b*

Color values were measured using an X-Rite Ci7800 spectrophotometer in reflectance. L*, a*, and b* values were calculated, assuming a D65 illuminant and a 10° standard observer. Each L*, a*, and b* color value presented in the examples below represents the average of six measurements.

### Density

Density was measured using a displacement method, according to ASTM D792. Density is an indication of the amount of voiding that occurs. PET has a specific gravity of about 1.36 g/cm³. Adding 4 wt % of an olefin will reduce the specific gravity of the composite blend by a small amount. For example, adding 4.0 wt % of a COC with a specific gravity of 1.02 g/cm³ to PET lowers the composite specific gravity to 1.34 g/cm³. A measured density lower than the calculated composite density indicates that voiding is occurring.

### EXAMPLES

The disclosed technology is next described by means of the following examples. The use of these and other examples anywhere in the specification is illustrative only, and in no way limits the scope and meaning of the disclosure or of any exemplified form. Likewise, the disclosure is not limited to any particular preferred embodiments described herein. Indeed, modifications and variations of the disclosure may be apparent to those skilled in the art upon reading this specification, and can be made without departing from its spirit and scope. The disclosure is therefore to be limited only by the terms of the claims, along with the full scope of equivalents to which the claims are entitled. All bottles described in the following examples are considered representative articles, and comparable results are expected for other types of articles.

### Example 1

Samples were prepared in which a minor amount (4 wt %) of incompatible polymer was added to a major amount (96 wt %) of dried PET (PQB7 manufactured by Polyquest). In one sample, no incompatible polymer was included, and TiO₂ was included instead as a control. Without an incompatible polymer, the TiO₂-containing composition would be non-pearlescent. Each mixture of pellets was fed into an extruder of a Nissei ASB-50 single stage blow molding machine, running at 280° C. 29.7 g preforms were injection molded and then stretched into bottles with an estimated stretching temperature of 105° C. The total orientation was estimated to be 3.38 axial and 2.63 circumferential for a total area draw ratio of 8.9×². Physical properties of the oriented bottles were assessed, and the results are shown in Table 1.

TABLE 1

| | | | | | | | DE_{CMC} | Visually | |
|---|---|---|---|---|---|---|---|---|---|
| Minor phase | Grade | L* | a* | b* | % LT | Density | Change | Pearlescent | T_{g} |
| 4 wt % COC | TOPAS 6013S- | 95.65 | −0.04 | −0.39 | 12.08 | 1.30 | 7.3 | No | 130° C. |
| | 04 | | | | | | | | |
| | (Polyplastics) | | | | | | | | |
| 4 wt % COC | ZEONOR | 92.85 | −0.15 | 0.71 | 49.84 | 1.33 | 12.4 | Yes | 102° C. |
| | 1020R | | | | | | | | |
| | (Zeonex) | | | | | | | | |
| 4 wt % COC | ZEONOR | 92.44 | −0.18 | 0.90 | 58.63 | 1.34 | 15.0 | Yes | 100° C. |
| | 1060R | | | | | | | | |
| | (Zeonex) | | | | | | | | |
| 4 wt % COC | TOPAS 8007F- | 92.62 | −0.05 | 0.71 | 45.47 | 1.33 | 34.2 | Yes | 70° C. |
| | 04 | | | | | | | | |
| | (Polyplastics) | | | | | | | | |
| 4 wt % PPRO | BAPOLENE | 94.45 | −0.03 | 0.48 | 31.50 | 1.33 | 17.2 | Yes | — |
| | 4802 | | | | | | | | |
| | (Bamberger | | | | | | | | |
| | Polymers) | | | | | | | | |
| 4 wt % PMP | TPX RT-31 | 96.38 | 0.03 | −0.10 | 7.61 | 1.25 | 16.5 | Yes | — |
| | (Mitsui) | | | | | | | | |
| 4 wt % LLDPE | BAPOLENE | 92.21 | 0.08 | 1.53 | 55.91 | 1.34 | 33.9 | Yes | — |
| | LDPE 1072 | | | | | | | | |
| | (Bamberger | | | | | | | | |
| | Polymers) | | | | | | | | |
| 4 wt % TiO₂, | CR-834 | 97.26 | −0.57 | 0.91 | 4.12 | 1.33 | 4.0 | No | N/A |
| added via a 50 | (Tronox) | | | | | | | | |
| wt % MB | | | | | | | | | |
| 3 wt % COC, | TOPAS 8007F- | — | — | — | 14.64 | — | — | Yes | 70° C. |
| 0.11 wt % SV 13, | 04 | | | | | | | | |
| 0.085 wt % SB 104 | (Polyplastics) | | | | | | | | |
| 3 wt % COC, | TOPAS 8007F- | — | — | — | 10.42 | — | — | Yes | 70° C. |
| 0.24 wt % SY 179, | 04 | | | | | | | | |
| 0.11 wt % SG 3 | (Polyplastics) | | | | | | | | |

### Example 2

The same set of samples as Example 1 was prepared, except for the total orientation of the preform. For Example 2, the orientation was estimated to be 3.3 axial and 3.3 circumferential for a total area draw ratio of 10.9×². Physical properties of the oriented bottles were assessed, and the results are shown in Table 2.

TABLE 2

| | | | | | | | DE_{CMC} | Visually | |
|---|---|---|---|---|---|---|---|---|---|
| Minor phase | Grade | L* | a* | b* | % LT | Density | Change | Pearlescent | T_{g} |
| 4 wt % COC | TOPAS 6013S-04 | 97.37 | −0.07 | −0.17 | 5.05 | 1.26 | 7.3 | No | 130° C. |
| | (Polyplastics) | | | | | | | | |
| 4 wt % COC | ZEONOR 1020R | 95.50 | 0.00 | 0.17 | 19.97 | 1.32 | 12.4 | Yes | 102° C. |
| | (Zeonex) | | | | | | | | |
| 4 wt % COC | ZEONOR 1060R | 94.92 | −0.06 | 0.56 | 32.31 | 1.33 | 15.0 | Yes | 100° C. |
| | (Zeonex) | | | | | | | | |
| 4 wt % COC | TOPAS 8007F-04 | 93.00 | −0.03 | 1.08 | 47.52 | 1.33 | 34.2 | Yes | 70° C. |
| | (Polyplastics) | | | | | | | | |
| 4 wt % PPRO | BAPOLENE 4802 | 94.84 | −0.02 | 0.62 | 27.2 | 1.33 | 17.2 | Yes | — |
| | (Bamberger | | | | | | | | |
| | Polymers) | | | | | | | | |
| 4 wt % PMP | TPX RT-31 | 96.41 | 0.04 | −0.03 | 6.48 | 1.23 | 16.5 | Yes | — |
| | (Mitsui) | | | | | | | | |
| 4 wt % LLDPE | BAPOLENE | 92.48 | 0.04 | 1.82 | 54.48 | 1.34 | 33.9 | Yes | — |
| | LDPE 1072 | | | | | | | | |
| | (Bamberger | | | | | | | | |
| | Polymers) | | | | | | | | |
| 4 wt % TiO₂, | CR-834 (Tronox) | 97.03 | −0.49 | 0.82 | 3.07 | 1.30 | 4.0 | No | N/A |
| added via a | | | | | | | | | |
| 50 wt % MB | | | | | | | | | |
| 3 wt % COC, | TOPAS 8007F-04 | — | — | — | 14.64 | — | — | Yes | 70° C. |
| 0.11 wt % SV 13, | (Polyplastics) | | | | | | | | |
| 0.085 wt % SB 104 | | | | | | | | | |
| 3 wt % COC, | TOPAS 8007F-04 | — | — | — | 10.42 | — | — | Yes | 70° C. |
| 0.24 wt % SY 179, | (Polyplastics) | | | | | | | | |
| 0.11 wt % SG 3 | | | | | | | | | |

All references cited and/or discussed in this specification are incorporated herein by reference in their entireties and to the same extent as if each reference was individually incorporated by reference.

We claim:

1. An oriented, pearlescent article comprising one or more layers, wherein at least one layer is a composition comprising:
polyester; and
incompatible polymer selected from COC, partially hydrogenated styrenic polymers and copolymers, and combinations thereof;
wherein the article is oriented and has a pearlescent gonioappearance of more than 15 units DE_{CMC} when measured between a 15° viewing angle and a 110° viewing angle from a 45° illuminant.

2. The article of claim 1, wherein the layer has a pearlescent gonioappearance of more than 10 units DE_{CMC} when measured between a 15° viewing angle and a 110° viewing angle from a 45° illuminant.

3. The article of claim 1, wherein the incompatible polymer has a glass transition temperature that is lower than the orientation temperature of the article.

4. The article of claim 1, wherein the polyester is polyethylene terephthalate (PET).

5. The article of claim 1, wherein the composition comprises at least 85 wt % polyester, based on the total weight of the composition.

6. The article of claim 1, wherein the incompatible polymer comprises a hydrogenated styrenic polymer.

7. The article of claim 1, wherein the incompatible polymer comprises COC.

8. The article of claim 1, wherein the composition comprises about 15 wt % or less incompatible polymer, based on the total weight of the composition.

9. The article of claim 1, wherein the composition further comprises an additive or colorant.

10. The article of claim 1, wherein the composition comprises an additive selected from anti-block agents, anti-oxidants, anti-stats, slip agents, chain extenders, cross linking agents, flame retardants, IV reducers, laser marking additives, mold release, optical brighteners, flow aids, colorants, plasticizers, pigment, dyes, nucleating agents, oxygen scavengers, anti-microbials, UV stabilizers, and combinations thereof.

11. The article of claim 1, wherein the composition comprises a colorant selected from dyes, organic pigments, inorganic pigments, and combinations thereof.

12. The article of claim 11, wherein the colorant comprises a combination of dyes.

13. The article of claim 1, wherein the article is a container.

14. A method of manufacturing a pearlescent article, comprising the steps of:
(a) melt blending polyester with incompatible polymer selected from COC, partially or fully hydrogenated styrenic polymers and copolymers, and combinations thereof to produce a composition comprising about 15 wt % or less of incompatible polymer, based on the total weight of the composition;
(b) subjecting the composition to orientation stress at a temperature above the glass transition temperature of the incompatible polymer; and
(c) producing an article that has a pearlescent gonioappearance of more than 15 units DE_{CMC} when measured between a 15° viewing angle and a 110° viewing angle from a 45° illuminant.

15. The method of claim 14, wherein at least one additive or colorant is added to the composition during step (a).
